(19) United States
(12) Patent Application Publication
(10) Pub. No.: US 2025/0001737 A1
(43) Pub. Date: Jan. 2, 2025

(54) POLYMER INTERLAYER WITH BLOCKED CORE LAYER

(71) Applicant: SOLUTIA INC., ST. LOUIS, MO (US)

(72) Inventor: WENJIE CHEN, AMHERST, MA (US)

(73) Assignee: SOLUTIA INC., ST. LOUIS, MO (US)

(21) Appl. No.: 18/687,018

(22) PCT Filed: Aug. 25, 2022
(86) PCT No.: PCT/US2022/041464

§ 371 Date: Feb. 27, 2024

Related U.S. Application Data
(60) Provisional application No. 63/260,872, filed on Sep. 3, 2021.

(51) Int. Cl. B32B 17/10; B29C 48/00; B29C 48/08; B29C 48/21; B29K 29/00; B29L 31/30; B32B 7/027

(52) U.S. Cl. CPC B32B 17/10761; B29C 48/0021; B29C 48/08; B29C 48/21; B32B 7/027; B32B 17/10036; B32B 17/10293; B32B 17/10568; B32B 17/10935; B29K 2029/00; B29K 2995/0012; B29L 2031/3052; B32B 2307/102; B32B 2307/30; B32B 2307/7376; B32B 2605/00

(57) ABSTRACT

A polymer interlayer that resists formation of optical defects. The polymer interlayer comprises a first polymer layer, a second polymer layer, and a third polymer layer. The first polymer layer is positioned between the second polymer layer and the third polymer layer. The first polymer layer has a glass transition temperature of less than about 20° C. and the second and third polymer layers each have a glass transition temperature of more than about 25° C. The polymer interlayer has an edge. The first polymer layer is not present within a portion of the polymer interlayer. The portion of the polymer interlayer extends a distance X from the edge of the polymer interlayer, with the distance X being between 0.2 and 40 cm.

### FIELD OF THE INVENTION

The present invention is related to the field of polymer interlayers and multiple layer panels comprising polymer interlayers. More specifically, the present invention is related to the field of polymer interlayers comprising multiple polymer layers.

### DESCRIPTION OF RELATED ART

Multiple layer panels are panels comprised of two sheets of a substrate (such as, but not limited to, glass, polyester, polyacrylate, or sandwiched polycarbonate) with one or more polymer interlayers therebetween. Laminated multiple layer glass panels are commonly utilized in architectural window applications and in the windows of motor vehicles and airplanes, and in photovoltaic solar panels. The first two applications are commonly referred to as laminated safety glass. The main function of the interlayer in the laminated safety glass is to absorb energy resulting from impact or force applied to the glass, to keep the layers of glass bonded even when the force is applied and the glass is broken, and to prevent the glass from breaking up into sharp pieces. Additionally, the interlayer may also give the glass a preferential sound insulation rating, reduce UV and/or IR light transmission, and enhance the aesthetic appeal of the associated window. For example, laminated glass panels with desirable acoustic properties have been produced, resulting in quieter internal spaces.

Furthermore, laminated glass panels have been used in vehicles equipped with heads-up display (“HUD”) systems (also referred to as head-up systems), which project an image of an instrument cluster or other important information to a location on the windshield at the eye level of the vehicle operator. Such a display allows the driver to stay focused on the upcoming path of travel while visually accessing dashboard information. Generally, the HUD system in an automobile or an aircraft uses the inner surface of the vehicle windscreen to partially reflect the projected image. However, there is a secondary reflection taking place at the outside surface of the vehicle windscreen that forms a weak secondary image or “ghost” image. Since these two reflective images are offset in position, double images are often observed, which cause an undesirable viewing experience to the driver. When the image is projected onto a windshield which has a uniform and consistent thickness, the interfering double, or reflected ghost, image is created due to the differences in the position of the projected image as it is reflected off the inside and outside surfaces of the glass.

One method of addressing these double or ghost images is to orient the inner and outer glass sheets at an angle from one another. This aligns the position of the reflected images to a single point, thereby creating a single image. Typically, this is done by displacing the outer sheet relative to the inner sheet by employing a wedge-shaped, or “tapered,” interlayer that includes at least one region of nonuniform thickness. Many conventional tapered interlayers include a constant wedge angle over the entire HUD region, although some interlayers have recently been developed that include multiple wedge angles over the HUD region.

In order to achieve the required property and performance characteristics for glass panels, it has become common practice to utilize multiple layer or multilayered interlayers. As used herein, the terms “multilayer” and “multiple layers” mean an interlayer having more than one layer, and multilayer and multiple layer may be used interchangeably. Multiple layer interlayers typically contain at least one soft layer and at least one stiff layer. As noted above, interlayers with one soft “core” layer sandwiched between two more rigid or stiff “skin” layers have been designed with sound insulation properties for the glass panel. Interlayers having the reverse configuration, that is, with one stiff layer sandwiched between two more soft layers have been found to improve the impact performance of the glass panel and can also be designed for sound insulation. Regardless, the soft “core” layer is generally referred to as an acoustic layer (as the soft layer beneficially reduces sound transmission), while the hard “skin” layer are referred to as conventional layer, or non-acoustic layers.

The layers of the interlayer are generally produced by mixing a polymer resin such as poly(vinyl butyral) with one or more plasticizers and melt processing the mix into a sheet by any applicable process or method known to one of skill in the art, including, but not limited to, extrusion, with the layers being combined by processes such as co-extrusion and lamination. In a trilayer interlayer, the core layer may include more plasticizer than the skin layers, such that the core layer is softer than the relatively harder skin layers. Other additional ingredients, as described in more detail below, may optionally be added for various other purposes. After the interlayer sheet is formed, it is typically collected and rolled for transportation and storage and for later use in the multiple layer glass panel, as discussed below.

The following offers a simplified description of the manner in which multiple layer glass panels are generally produced in combination with the interlayers. First, a multiple layer interlayer may be co-extruded using a multiple manifold co-extrusion device. The device operates by simultaneously extruding polymer melts from each manifold toward an extrusion opening. Properties of the layers can be varied by adjusting attributes (e.g., temperature and/or opening dimensions) of the die lips at the extrusion opening. Once formed, the interlayer sheet can be placed between two glass substrates and any excess interlayer is trimmed from the edges, creating an assembly. It is not uncommon for multiple polymer interlayer sheets or a polymer interlayer sheet with multiple layers (or a combination of both) to be placed within the two glass substrates creating a multiple layer glass panel with multiple polymer interlayers. Then, air is removed from the assembly by an applicable process or method known to one of skill in the art; e.g., through nip rollers, vacuum bag or another deairing mechanism. Additionally, the interlayer is partially press-bonded to the substrates by any method known to one of ordinary skill in the art. In a last step, in order to form a final unitary structure, this preliminary bonding is rendered more permanent by a high temperature and pressure lamination process, or any other method known to one of ordinary skill in the art such as, but not limited to, autoclaving.

Multilayer interlayers such as a trilayer interlayer having a soft core layer and two stiffer skin layers are known to provide beneficial acoustic damping properties. However, such interlayers, as well as glass panels containing these interlayers, can develop optical defects commonly known as “bubbles.” Specifically, during the manufacturing process of laminated multiple layer glass panel constructs, bubbles commonly appear in the soft core of the interlayer. Often, such bubbles are in the form of trim or edge bubbles, which appear near the edges of the laminated panels. Specifically, edge bubbles are bubbles that form within a laminated glass panel, and particularly, within about 5 mm from edges of the glass sheets of the glass panel. Trim bubbles are bubbles that form in excess trim portions of the interlayer that extend beyond the edges of the glass sheets of the laminated glass panel. Most of these bubbles become visible when the autoclave pressure is released. It is commonly understood that bubble counts and bubble sizes can depend upon the moisture level in the autoclave, autoclave temperature, autoclave pressure, autoclave pressure releasing temperature, and etc. For instance, bubble nucleation may occur inside the core layer after the pressure of the polymer drops below the solubility pressure. Other variables that are known to attribute to the bubble problem include environmental contaminates and the rheology characteristics of the interlayers.

In view of the above, there is a need in the art for the development of a multilayered interlayer that resists the formation of these optical defects (i.e., bubbles) without a reduction in other optical, mechanical, and acoustic characteristics of a conventional multilayered interlayer. More specifically, there is a need in the art for the development of multilayered interlayers having at least one soft core layer and one stiff skin layer that resists the generation of bubbles (e.g., trim or edge bubbles).

### BRIEF DESCRIPTION OF THE DRAWINGS

FIG. 1 is a schematic illustration of a laminated glass panel comprising a pair of glass sheets opposing a polymer interlayer, with the polymer interlayer comprising a trilayer with a pair of skin layers opposing a core layer;

FIG. 2a is another schematic illustration of a laminated glass panel comprising a pair of glass sheets opposing a polymer interlayer, with the polymer interlayer comprising a trilayer with a pair of skin layers opposing a core layer, and with the polymer interlayer having a wedge shape formed by thicknesses of the skin layers increasing along at least a portion of a length of the glass panel;

FIG. 2b is yet another schematic illustration of a laminated glass panel comprising a pair of glass sheets opposing a polymer interlayer, with the polymer interlayer comprising a trilayer with a pair of skin layers opposing a core layer, and with the polymer interlayer having a wedge shape formed by a thickness of the core layer increasing along at least a portion of a length of the glass panel;

FIG. 3 is a top schematic view of a laminated glass panel according to embodiments of the present invention, particularly illustrating part of the laminated glass panel comprising a non-core portion;

FIG. 4 is a cross section of a laminated glass panel according to embodiments of the present invention, with the laminated glass panel including a polymer interlayer having generally a constant thickness, and with a non-core portion of the polymer interlayer extending a distance from an edge of the laminated glass panel;

FIG. 5 is a cross section of a laminated glass panel according to embodiments of the present invention, with the laminated glass panel including a polymer interlayer having a wedge shape, with a non-core portion of the polymer interlayer extending a distance from an edge of the laminated glass panel, and with the non-core portion present in a thicker area of the polymer interlayer;

FIG. 6 is a cross section of a laminated glass panel according to embodiments of the present invention, with the laminated glass panel including a polymer interlayer having a wedge shape, with a non-core portion of the polymer interlayer extending a distance from an edge of the laminated glass panel, and with the non-core portion present in a thinner area of the polymer interlayer;

FIG. 7 is a cross section of a laminated glass panel according to embodiments of the present invention, with the laminated glass panel including a polymer interlayer having generally a constant thickness, with a non-core portion of the polymer interlayer extending a distance from an edge of the laminated glass panel, and wherein a core layer of the polymer interlayer extends with a diminishing thickness at least partly into the non-core portion of the polymer interlayer;

FIG. 8 is a chart illustrating sound transmission loss data for a first four laminated glass panels;

FIG. 9 is a chart illustrating sound transmission loss data for a second four laminated glass panels;

FIG. 10 is a chart illustrating average sound transmission loss data for eight laminated glass panels across a 2-4 KHz frequency range; and

FIG. 11 is a chart illustrating average sound transmission loss data for eight laminated glass panels across a 5-10 KHz frequency range.

### SUMMARY

One aspect of the present invention concerns a polymer interlayer that resists formation of optical defects. The polymer interlayer comprises a first polymer layer, a second polymer layer, and a third polymer layer. The first polymer layer is positioned between the second polymer layer and the third polymer layer. The first polymer layer has a glass transition temperature of less than about 20° C., and the second and third polymer layers have a glass transition temperature of more than about 25° C. The polymer interlayer has an edge. The first polymer layer is not present within a portion of the polymer interlayer. The portion of the polymer interlayer extends a distance X from the edge of the polymer interlayer, with the distance X being between 0.2 and 40 cm.

A further aspect of the present invention concerns a method of forming a polymer interlayer that resists formation of optical defects. The method comprises the step of extruding a first polymer melt to form a first polymer layer. The first polymer layer has a glass transition temperature of less than about 20° C. An additional step includes extruding a second polymer melt to form a second polymer layer and a third polymer layer. The second and third polymer layers each have a glass transition temperature of more than about 25° C. The first polymer layer is positioned between the second polymer layer and the third polymer layer. The polymer interlayer has an edge. The first polymer layer is not present within a portion of the polymer interlayer. The portion of the polymer interlayer extends a distance X from the edge of the polymer interlayer, with the distance X being between 0.2 and 40 cm.

### DETAILED DESCRIPTION

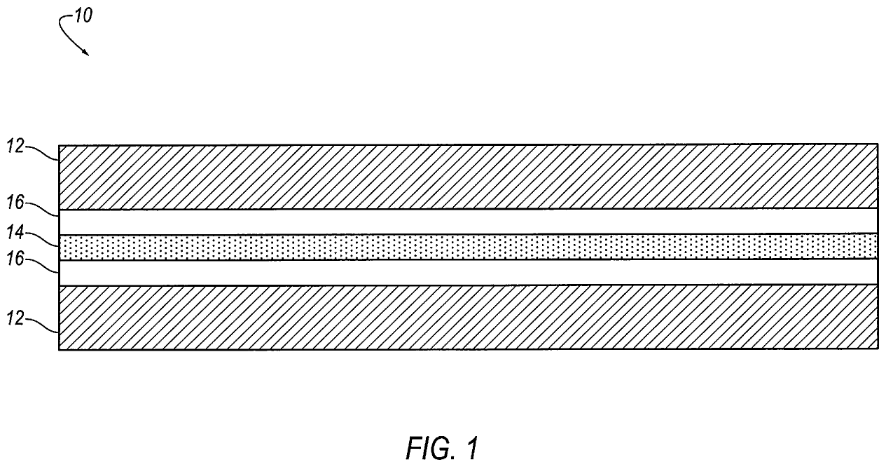

Embodiments of the present invention are directed to multiple layer panels and methods of making multiple layer panels. Generally, multiple layer panels are comprised of two sheets of glass, or other applicable substrates, with a polymer interlayer sheet or sheets sandwiched there-between. Multiple layer panels are generally produced by placing at least one polymer interlayer sheet between two substrates to create an assembly. FIG. 1 illustrates a multiple layer panel 10 comprising a pair of glass sheets 12 with a multilayered interlayer sandwiched therebetween. The multilayered interlayer is configured as a trilayer interlayer having three individual polymer interlayer sheets, including a soft core layer 14 and two relatively stiffer skin layers 16 positioned on either side of the core layer 14.

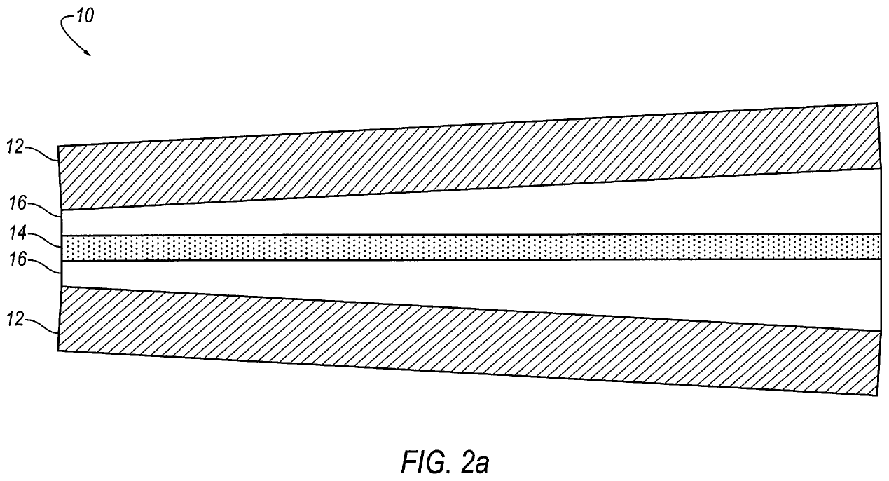

In some embodiments, the interlayer (e.g., the core layer 14 and the skin layers 16) will have a generally constant or uniform thickness about the length of the interlayer. However, in alternative embodiments, as shown in FIGS. 2a and 2b, the interlayer may have at least one region of non-uniform thickness. For example, the interlayer, comprised of the core layer 14 and skin layers 16, may be wedge-shaped, such that the thickness of the interlayer changes (e.g., linearly or non-linearly) about the length of the interlayer. In some such embodiments, as shown in FIG. 2b, the thickness of the interlayer may change due to a thickness change in the core layer 14 (i.e., with the skin layers 16 having a generally constant thickness). Alternatively, as shown in FIG. 2a, the thickness of the interlayer may change due to a thickness change in the skin layers 16 (i.e., with the core layer 14 having a generally constant thickness). In further alternatives, the thickness of the interlayer may change due to a thickness change in both the core layer 14 and the skin layers 16.

In order to facilitate a more comprehensive understanding of the interlayers and multiple layer panels disclosed herein, the meaning of certain terms, as used in this application, will be defined. These definitions should not be taken to limit these terms as they are understood by one of ordinary skill, but simply to provide for improved understanding of how certain terms are used herein.

The terms “polymer interlayer sheet,” “interlayer,” “polymer layer”, and “polymer melt sheet” as used herein, may designate a single-layer sheet or a multilayered interlayer. A “single-layer sheet,” as the names implies, is a single polymer layer extruded as one layer. A multilayered interlayer, on the other hand, may comprise multiple layers, including separately extruded layers, co-extruded layers, or any combination of separately and co-extruded layers. Thus, the multilayered interlayer could comprise, for example: two or more single-layer sheets combined together (“plural-layer sheet”); two or more layers co-extruded together (“co-extruded sheet”); two or more co-extruded sheets combined together; a combination of at least one single-layer sheet and at least one co-extruded sheet; and a combination of at least one plural-layer sheet and at least one co-extruded sheet. In various embodiments of the present invention, a multilayered interlayer comprises at least two polymer layers (e.g., a single layer or multiple layers co-extruded) disposed in direct contact with each other, wherein each layer comprises at least one polymer resin. The term “resin,” as utilized herein refers to the polymeric component (e.g., PVB) removed from the processes, such as those discussed more fully below. Generally, plasticizer, such as those discussed more fully below, is added to the resins to result in a plasticized polymer. Additionally, resins may have other components in addition to the polymer and plasticizer as further discussed below.

It should also be noted that while poly(vinyl butyral) (“PVB”) interlayers are often specifically discussed as the polymer resin of the polymer interlayers in this application, it should be understood that other thermoplastic interlayers besides PVB interlayers may be used. Contemplated polymers include, but are not limited to, polyurethane, polyvinyl chloride, poly(ethylene vinyl acetate) and combinations thereof. These polymers can be utilized alone, or in combination with other polymers. Accordingly, it should be understood that when ranges, values and/or methods are given for a PVB interlayer in this application (e.g., plasticizer component percentages, thickness and characteristic-enhancing additives), those ranges, values and/or methods also apply, where applicable, to the other polymers and polymer blends disclosed herein or could be modified, as would be known to one of ordinary skill, to be applied to different materials.

As used herein, the term “molecular weight” refers to weight average molecular weight (Mw). The molecular weight of the PVB resin can be in the range of from about 50,000 to about 600,000, about 70,000 to about 450,000, or about 100,000 to about 425,000 Daltons.

The PVB resin may be produced by known aqueous or solvent acetalization processes by reacting polyvinyl alcohol (“PVOH”) with butyraldehyde in the presence of an acid catalyst, separation, stabilization, and drying of the resin. Such acetalization processes are disclosed, for example, in U.S. Pat. Nos. 2,282,057 and 2,282,026 and Wade, B. (2016), “Vinyl Acetal Polymers”, Encyclopedia of Polymer Science and Technology, pp. 1-22 (John Wiley & Sons, Inc.), the entire disclosures of which are incorporated herein by reference.

While generally referred herein as “poly(vinyl butyral)” “poly(vinyl acetal)”, the resins described herein may include residues of any suitable aldehyde, including, but not limited to, isobutyraldehyde, as previously discussed. In some embodiments, one or more poly(vinyl acetal) resin can include residues of at least one C₁ to C₁₀ aldehyde, or at least one C₄ to C₈ aldehyde. Examples of suitable C₄ to C₈ aldehydes can include, but are not limited to, n-butyraldehyde, isobutyraldehyde, 2-methylvaleraldehyde, n-hexyl aldehyde, 2-ethylhexyl aldehyde, n-octyl aldehyde, and combinations thereof.

In many embodiments, plasticizers are added to the polymer resin to form polymer layers or interlayers. Plasticizers are generally added to the polymer resin to increase the flexibility and durability of the resultant polymer interlayer. Plasticizers function by embedding themselves between chains of polymers, spacing them apart (increasing the “free volume”) and thus significantly lowering the glass transition temperature (T_{g}) of the polymer resin, making the material softer and more elastic. In this regard, the amount of plasticizer in the interlayer can be adjusted to affect the glass transition temperature (T_{g}). The glass transition temperature (T_{g}) is the temperature that marks the transition from the glassy state of the interlayer to the rubbery state. The glass transition temperature (T_{g}) can be determined by dynamical mechanical thermal analysis (DMTA) in shear mode. The DMTA measures the storage (elastic) modulus (G′) in Pascals, loss (viscous) modulus (G″) in Pascals, tan delta (=G″/G′) of the specimen as a function of temperature at a given frequency, and temperature sweep rate. A frequency of 1 Hz and temperature sweep rate of 3° C./min were used herein. The T_{g} is determined by the position of the tan delta peak on the temperature scale in ° C. and the tan delta peak value is referred as tan delta or peak tan delta. As used herein, “tan delta”, “peak tan delta”, “tan σ” and “peak tan 0” may be used interchangeably.

In general, higher amounts of plasticizer loading can result in lower T_{g}. In some embodiments, such as when the interlayer is an acoustic trilayer, the inner core layer (i.e., the soft layer) will have a glass transition temperature less than about 20° C., while the outer skin layers (e.g., the stiff layer) will have a glass transition temperature greater than about 25° C.

Contemplated plasticizers include, but are not limited to, esters of a polybasic acid, a polyhydric alcohol, triethylene glycol di-(2-ethylbutyrate), triethylene glycol di-(2-ethylhexonate) (known as “3-GEH”), triethylene glycol diheptanoate, tetraethylene glycol diheptanoate, dihexyl adipate, dioctyl adipate, hexyl cyclohexyladipate, mixtures of heptyl and nonyl adipates, diisononyl adipate, heptylnonyl adipate, dibutyl sebacate, and polymeric plasticizers such as oil-modified sebacic alkyds and mixtures of phosphates and adipates, and mixtures and combinations thereof. 3-GEH is particularly preferred. Other examples of suitable plasticizers can include, but are not limited to, tetraethylene glycol di-(2-ethylhexanoate) (“4-GEH”), di(butoxyethyl) adipate, and bis(2-(2-butoxyethoxy)ethyl) adipate, dioctyl sebacate, nonylphenyl tetraethylene glycol, and mixtures thereof.

Other suitable plasticizers may include blends of two or more distinct plasticizers, including but not limited to those plasticizers described above. Still other suitable plasticizers, or blends of plasticizers, may be formed from aromatic groups, such polyadipates, epoxides, phthalates, terephthalates, benzoates, toluates, mellitates and other specialty plasticizers. Further examples include, but are not limited to, dipropylene glycol dibenzoate, tripropylene glycol dibenzoate, polypropylene glycol dibenzoate, isodecyl benzoate, 2-ethylhexyl benzoate, diethylene glycol benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluate, triethylene glycol di-o-toluate, dipropylene glycol di-o-toluate, 1,2-octyl dibenzoate, tri-2-ethylhexyl trimellitate, di-2-ethylhexyl terephthalate, bis-phenol A bis(2-ethylhexaonate), ethoxylated nonylphenol, and mixtures thereof. In some embodiments, the plasticizer can be selected from the group consisting of dipropylene glycol dibenzoates, tripropylene glycol dibenzoates, and combinations thereof.

Generally, the plasticizer content of the polymer interlayers of this application are measured in parts per hundred resin parts (“phr”), on a weight per weight basis. For example, if 30 grams of plasticizer is added to 100 grams of polymer resin, the plasticizer content of the resulting plasticized polymer would be 30 phr. When the plasticizer content of a polymer layer is given in this application, the plasticizer content of the particular layer is determined in reference to the phr of the plasticizer in the melt that was used to produce that particular layer. In some embodiments, the high rigidity interlayer comprises a layer having a plasticizer content of less than about 35 phr and less than about 30 phr.

According to some embodiments of the present invention, one or more polymer layers described herein can have a total plasticizer content of at least about 20 phr, at least about 25 phr, at least about 30 phr, at least about 35 phr, at least about 38 phr, at least about 40 phr, at least about 45 phr, at least about 50 phr, at least about 55 phr, at least about 60 phr, at least about 65 phr, at least about 67 phr, at least about 70 phr, at least about 75 phr of one or more plasticizers. In some embodiments, the polymer layer may also include not more than about 100 phr, not more than about 85 phr, not more than 80 phr, not more than about 75 phr, not more than about 70 phr, not more than about 65 phr, not more than about 60 phr, not more than about 55 phr, not more than about 50 phr, not more than about 45 phr, not more than about 40 phr, not more than about 38 phr, not more than about 35 phr, or not more than about 30 phr of one or more plasticizers. In some embodiments, the total plasticizer content of at least one polymer layer can be in the range of from about 20 to about 40 phr, about 20 to about 38 phr, or about 25 to about 35 phr. In other embodiments, the total plasticizer content of at least one polymer layer can be in the range of from about 38 to about 90 phr, about 40 to about 85 phr, or about 50 to 70 phr.

When the interlayer includes a multiple layer interlayer, two or more polymer layers within the interlayer may have the substantially the same plasticizer content and/or at least one of the polymer layers may have a plasticizer content different from one or more of the other polymer layers. When the interlayer includes two or more polymer layers having different plasticizer contents, the two layers may be adjacent to one another. In some embodiments, the difference in plasticizer content between adjacent polymer layers can be at least about 1, at least about 2, at least about 5, at least about 7, at least about 10, at least about 20, at least about 30, at least about 35 phr and/or not more than about 80, not more than about 55, not more than about 50, or not more than about 45 phr, or in the range of from about 1 to about 60 phr, about 10 to about 50 phr, or about 30 to 45 phr. When three or more layers are present in the interlayer, at least two of the polymer layers of the interlayer may have similar plasticizer contents falling for example, within 10, within 5, within 2, or within 1 phr of each other, while at least two of the polymer layers may have plasticizer contents differing from one another according to the above ranges.

In some embodiments, one or more polymer layers or interlayers described herein may include a blend of two or more plasticizers including, for example, two or more of the plasticizers listed above. When the polymer layer includes two or more plasticizers, the total plasticizer content of the polymer layer and the difference in total plasticizer content between adjacent polymer layers may fall within one or more of the ranges above. When the interlayer is a multiple layer interlayer, one or more than one of the polymer layers may include two or more plasticizers. In some embodiments when the interlayer is a multiple layer interlayer, at least one of the polymer layers including a blend of plasticizers may have a glass transition temperature higher than that of conventional plasticized polymer layer. This may provide, in some cases, additional stiffness to layer which can be used, for example, as an outer “skin” layer in a multiple layer interlayer.

In addition to plasticizers, it is also contemplated that adhesion control agents (“ACAs”) can also be added to the polymer resins to form polymer interlayers. ACAs generally function to alter and/or improve the adhesion of the interlayer to the glass panels when forming a laminated panel.

Contemplated ACAs include, but are not limited to, magnesium carboxylates/salts. In addition, contemplated ACAs may also include those ACAs disclosed in U.S. Pat. No. 5,728,472, incorporated by reference herein in its entirety, such as residual sodium acetate, potassium acetate, and/or magnesium bis(2-ethyl butyrate).

Other additives may be incorporated into the interlayer to enhance its performance in a final product and impart certain additional properties to the interlayer. Such additives include, but are not limited to, dyes, pigments (e.g., to create a gradient color shade band at the upper side of the laminated glass), stabilizers (e.g., ultraviolet stabilizers), antioxidants, anti-blocking agents, flame retardants, IR absorbers or blockers (e.g., indium tin oxide, antimony tin oxide, lanthanum hexaboride (LaB₆) and cesium tungsten oxide), processing aides, flow enhancing additives, lubricants, impact modifiers, nucleating agents, thermal stabilizers, UV absorbers, UV stabilizers, dispersants, surfactants, chelating agents, coupling agents, adhesives, primers, reinforcement additives, and fillers, among other additives known to those of ordinary skill in the art.

One parameter used to describe the polymer resin components of the polymer interlayers of this application is residual hydroxyl content (as vinyl hydroxyl content or poly(vinyl alcohol) (“PVOH”) content). Residual hydroxyl content refers to the amount of hydroxyl groups remaining as side groups on the chains of the polymer after processing is complete. For example, PVB can be manufactured by hydrolyzing poly(vinyl acetate) to poly(vinyl alcohol), and then reacting the poly(vinyl alcohol) with butyraldehyde to form PVB. In the process of hydrolyzing the poly(vinyl acetate), typically not all of the acetate side groups are converted to hydroxyl groups. Further, the reaction with butyraldehyde typically will not result in all of the hydroxyl groups being converted into acetal groups. Consequently, in any finished PVB, there will typically be residual acetate groups (such as vinyl acetate groups) and residual hydroxyl groups (such as vinyl hydroxyl groups) as side groups on the polymer chain. Generally, the residual hydroxyl content of a polymer can be regulated by controlling the reaction times and reactant concentrations, among other variables in the polymer manufacturing process. When utilized as a parameter herein, the residual hydroxyl content is measured on a weight percent basis per ASTM D-1396.

In various embodiments, the poly(vinyl butyral) resin comprises about 8 to about 35 weight percent (wt. %) residual hydroxyl groups calculated as PVOH, about 13 to about 30 wt. % residual hydroxyl groups calculated as PVOH, about 8 to about 22 wt. % residual hydroxyl groups calculated as PVOH, or about 15 to about 22 wt. % residual hydroxyl groups calculated as PVOH; and for some of the high rigidity interlayers disclosed herein, for one or more of the layers, the poly(vinyl butyral) resin comprises greater than about 19 wt. % residual hydroxyl groups calculated as PVOH, greater than about 20 wt. % residual hydroxyl groups calculated as PVOH, greater than about 20.4 wt. % residual hydroxyl groups calculated as PVOH, and greater than about 21 wt. % residual hydroxyl groups calculated as PVOH.

In some embodiments, the poly(vinyl butyral) resin used in at least one polymer layer of an interlayer may include a poly(vinyl butyral) resin that has a residual hydroxyl content of at least about 16, at least about 18, at least about 18.5, at least about 18.7, at least about 19, at least about 19.5, at least about 20, at least about 20.5, at least about 21, at least about 21.5, at least about 22, at least about 22.5 wt. % and/or not more than about 30, not more than about 29, not more than about 28, not more than about 27, not more than about 26, not more than about 25, not more than about 24, not more than about 23, or not more than about 22 wt. %, measured as described above.

Additionally, one or more other polymer layers in the interlayers described herein may include another poly(vinyl butyral) resin that has a lower residual hydroxyl content. For example, in some embodiments, at least one polymer layer of the interlayer can include a poly(vinyl butyral) resin having a residual hydroxyl content of at least about 8, at least about 8.5, at least about 9, at least about 9.5, at least about 10, at least about 10.5, at least about 11, at least about 11.5, at least about 12, at least about 13 wt. % and/or not more than about 16, not more than about 15, not more than about 14, not more than about 13.5, not more than about 13, not more than about 12, or not more than about 11 wt. %, measured as described above.

When the interlayer includes two or more polymer layers, the layers may include poly(vinyl butyral) resins that have substantially the same residual hydroxyl content, or the residual hydroxyl contents of the poly(vinyl butyral) resins in each layer may differ from each other. When two or more layers include poly(vinyl butyral) resins having substantially the same residual hydroxyl content, the difference between the residual hydroxyl contents of the poly(vinyl butyral) resins in each layer may be less than about 2, less than about 1, or less than about 0.5 wt. %. As used herein, the terms “weight percent different” and “the difference between . . . is at least . . . weight percent” refer to a difference between two given weight percentages, calculated by subtracting one number from the other. For example, a poly(vinyl acetal) resin having a residual hydroxyl content of 12 wt. % has a residual hydroxyl content that is 2 wt. % different than a poly(vinyl acetal) resin having a residual hydroxyl content of 14 wt. % (14 wt. %-12 wt. %=2 wt. %). As used herein, the term “different” can refer to a value that is higher than or lower than another value. Unless otherwise specified, all “differences” herein refer to the numerical value of the difference and not to the specific sign of the value due to the order in which the numbers were subtracted. Accordingly, unless noted otherwise, all “differences” herein refer to the absolute value of the difference between two numbers.

When two or more layers include poly(vinyl butyral) resins having different residual hydroxyl contents, the difference between the residual hydroxyl contents of the poly(vinyl butyral) resins can be at least about 2, at least about 3, at least about 4, at least about 5, at least about 6, at least about 7, at least about 8, at least about 9, at least about 10, at least about 12, or at least about 15 wt. %, measured as described above.

The resin can also comprise less than 35 wt. % residual ester groups, less than 30 wt. %, less than 25 wt. %, less than 15 wt. %, less than 13 wt. %, less than 11 wt. %, less than 9 wt. %, less than 7 wt. %, less than 5 wt. %, or less than 1 wt. % residual ester groups calculated as polyvinyl ester, e.g., acetate, with the balance being an acetal, preferably butyraldehyde acetal, but optionally including other acetal groups in a minor amount, for example, a 2-ethyl hexanal group (see, for example, U.S. Pat. No. 5,137,954, the entire disclosure of which is incorporated herein by reference). The residual acetate content of a resin may also be determined according to ASTM D-1396.

In some embodiments, as described above, one or more of the polymer layers of the interlayer may be formed from poly(vinyl acetal) resin. Such poly(vinyl acetal) resin may have a residual acetate content of at least about 1, at least about 3, at least about 5, at least about 7 wt. % and/or not more than about 15, not more than about 12, not more than about 10, or not more than about 8 wt. %, measured as described above. When the interlayer comprises a multiple layer interlayer, two or more polymer layers can include resins having substantially the same residual acetate content, or one or more resins in various layers can have substantially different acetate contents. When the residual acetate contents of two or more resins are substantially the same, the difference in the residual acetate contents may be, for example, less than about 3, less than about 2, less than about 1, or less than about 0.5 wt. %. In some embodiments, the difference in residual acetate content between two or more poly(vinyl butyral) resins in a multiple layer interlayer can be at least about 3, at least about 5, at least about 8, at least about 15, at least about 20, or at least about 30 wt. %. When such resins are utilized in a multiple layer interlayer, the resins having different residual acetate contents may be located in adjacent polymer layers. When the multiple layer interlayer is a three-layer interlayer including a pair of outer “skin” layers surrounding, or sandwiching, an inner “core” layer, for example, the core layer may include a resin having higher or lower residual acetate content. At the same time, the resin in the inner core layer can have a residual hydroxyl content that is higher or lower than the residual hydroxyl content of the outer skin layer and fall within one or more of the ranges provided previously.

Poly(vinyl acetal) resins having higher or lower residual hydroxyl contents and/or residual acetate contents may also, when combined with at least one plasticizer, ultimately include different amounts of plasticizer. As a result, layers or domains formed of first and second poly(vinyl acetal) resins having different compositions may also have different properties within a single polymer layer or interlayer. Notably, for a given type of plasticizer, the compatibility of the plasticizer in the polymer is largely determined by the hydroxyl content of the polymer. Polymers with a greater residual hydroxyl content are typically correlated with reduced plasticizer compatibility or capacity. Conversely, polymers with a lower residual hydroxyl content typically will result in increased plasticizer compatibility or capacity. As a result, poly(vinyl acetal) resins with higher residual hydroxyl contents tend to be less plasticized and exhibit higher stiffness than similar resins having lower residual hydroxyl contents. Conversely, poly(vinyl acetal) resins having lower residual hydroxyl contents may tend to, when plasticized with a given plasticizer, incorporate higher amounts of plasticizer, which may result in a softer polymer layer that exhibits a lower glass transition temperature than a similar resin having a higher residual hydroxyl content. Depending on the specific resin and plasticizer, these trends could be reversed.

When two poly(vinyl acetal) resins having different levels of residual hydroxyl content are blended with a plasticizer, the plasticizer may partition between the polymer layers or domains, such that more plasticizer can be present in the layer or domain having the lower residual hydroxyl content and less plasticizer may be present in the layer or domain having the higher residual hydroxyl content. Ultimately, a state of equilibrium is achieved between the two resins. Generally, this correlation between the residual hydroxyl content of a polymer and plasticizer compatibility/capacity can be manipulated and exploited to allow for addition of the proper amount of plasticizer to the polymer resin and to stably maintain differences in plasticizer content within multilayered interlayers. Such a correlation also helps to stably maintain the difference in plasticizer content between two or more resins when the plasticizer would otherwise migrate between the resins.

As a result of the migration of plasticizer within an interlayer, the glass transition temperatures of one or more polymer layers may be different when measured alone or as part of a multiple layer interlayer. In some embodiments, the interlayer can include at least one polymer layer having a glass transition temperature, outside of an interlayer, of at least about 25, of at least about 33, at least about 34, at least about 35, at least about 36, at least about 37, at least about 38, at least about 39, at least about 40, at least about 41, at least about 42, at least about 43, at least about 44, at least about 45, or at least about 46° C. In some embodiments, the same layer may have a glass transition temperature within the polymer layer of at least about 34, at least about 35, at least about 36, at least about 37, at least about 38, at least about 39, at least about 40, at least about 41, at least about 42, at least about 43, at least about 44, at least about 45, at least about 46, at least about 47° C.

In the same or other embodiments, at least one other polymer layer of the multiple layer interlayer can have a glass transition temperature less than 30° C. and may, for example, have a glass transition temperature of not more than about 25, not more than about 20, not more than about 15, not more than about 10, not more than about 9, not more than about 8, not more than about 7, not more than about 6, not more than about 5, not more than about 4, not more than about 3, not more than about 2, not more than about 1, not more than about 0, not more than about −1, not more than about −2° C., or not more than about −5° C., measured when the interlayer is not part of an interlayer. The same polymer layer may have a glass transition temperature of not more than about 25, not more than about 20, not more than about 15, not more than about 10, not more than about 9, not more than about 8, not more than about 7, not more than about 6, not more than about 5, not more than about 4, not more than about 3, not more than about 2, not more than about 1, or not more than about 0° C., when measured outside of the interlayer.

According to some embodiments, the difference between the glass transition temperatures of two polymer layers, typically adjacent polymer layers within an interlayer, can be at least about 5, at least about 10, at least about 15, at least about 20, at least about 25, at least about 30, at least about 35, at least about 40, or at least about 45° C., while in other embodiments, two or more polymer layers can have a glass transition temperature within about 5, about 3, about 2, or about 1° C. of each other. Generally, the lower glass transition temperature layer has a lower stiffness than the higher glass transition temperature layer or layers in an interlayer and may be located between higher glass transition temperature polymer layers in the final interlayer construction.

For example, in some embodiments of this application, the increased acoustic attenuation properties of soft layers are combined with the mechanical strength of stiff/rigid layers to create a multilayered interlayer. In these embodiments, a central soft layer is sandwiched between two stiff/rigid outer layers. This configuration of (stiff)//(soft)//(stiff) creates a multilayered interlayer that is easily handled, can be used in conventional lamination methods and that can be constructed with layers that are relatively thin and light. The soft layer is generally characterized by a lower residual hydroxyl content (e.g., less than or equal to 16 wt. %, less than or equal to 15 wt. %, or less than or equal to 12 wt. % or any of the ranges disclosed above), a higher plasticizer content (e.g., greater than or equal to about 48 phr or greater than or equal to about 70 phr, or any of the ranges disclosed above) and/or a lower glass transition temperature (e.g., less than 30° C. or less than 10° C., or any of the ranges disclosed above).

It is contemplated that polymer interlayer sheets as described herein may be produced by any suitable process known to one of ordinary skill in the art of producing polymer interlayer sheets that are capable of being used in a multiple layer panel (such as a glass laminate). For example, it is contemplated that the polymer interlayer sheets may be formed through solution casting, compression molding, injection molding, melt extrusion, melt blowing or any other procedures for the production and manufacturing of a polymer interlayer sheet known to those of ordinary skill in the art. Further, in embodiments where multiple polymer interlayers are utilized, it is contemplated that these multiple polymer interlayers may be formed through co-extrusion, blown film, dip coating, solution coating, blade, paddle, air-knife, printing, powder coating, spray coating or other processes known to those of ordinary skill in the art. While all methods for the production of polymer interlayer sheets known to one of ordinary skill in the art are contemplated as possible methods for producing the polymer interlayer sheets described herein, this application will focus on polymer interlayer sheets produced through extrusion and/or co-extrusion processes. The final multiple layer glass panel laminate of the present disclosure are formed using processes known in the art.

In the extrusion process, thermoplastic resin and plasticizers, including any of those resins and plasticizers described above, are generally pre-mixed and fed into an extruder device. Additives such as colorants and UV inhibitors (in liquid, powder, or pellet form) may be used and can be mixed into the thermoplastic resin or plasticizer prior to arriving in the extruder device. These additives are incorporated into the thermoplastic polymer resin, and by extension the resultant polymer interlayer sheet, to enhance certain properties of the polymer interlayer sheet and its performance in the final multiple layer glass panel product.

In the extruder device, the thermoplastic raw material and plasticizers, including any of those resins, plasticizers, and other additives described above, are further mixed and melted, resulting in a resin melt that is generally uniform in temperature and composition. Embodiments of the present invention may provide for the melt temperature to be approximately 200° C. Once the melt reaches the end of the extruder device, the melt is propelled into the extruder die. The extruder die is the component of the extruder device which gives the final polymer interlayer sheet product its profile. The die will generally have an opening, defined by a lip, that is substantially greater in one dimension than in a perpendicular dimension. Generally, the die is designed such that the melt evenly flows from a cylindrical profile coming out of the die and into the product's end profile shape. A plurality of shapes can be imparted to the end polymer interlayer sheet by the die. This is accomplished by pushing or drawing a material through a die of the desired cross-section for the end product.

In some embodiments, a co-extrusion process may be utilized. Co-extrusion is a process by which multiple layers of polymer material are extruded simultaneously. Generally, this type of extrusion utilizes two or more extruders to melt and deliver a steady volume throughput of different thermoplastic melts of different viscosities or other properties through a co-extrusion die into the desired final form. For example, the multiple layer interlayers of the present invention (e.g., in the form of a trilayer interlayer) may be preferably co-extruded using a multiple manifold co-extrusion device which includes a first die manifold, a second die manifold, and a third die manifold. The co-extrusion device may operate by simultaneously extruding polymer melts from each manifold through a die and out of the opening, where the multiple layer interlayer is extruded as a composite of three individual polymer layers. The polymer melts may flow through the die such that the core layer is positioned between the skin layers, so as to result in the manufacture of a trilayer interlayer with the core layer sandwiched between the skin layers (see, e.g., FIGS. 1, 2a and 2b). The die opening may include a pair of lips positioned on either side of the opening. Given the positional orientation of the polymer melts, the skin layers may come into contact with the lips. Regardless, the interlayer thickness can be varied by adjusting the distance between die lips located at the die opening.

The thickness of the multiple polymer layers leaving the extrusion die in the co-extrusion process can generally be controlled by adjustment of the relative speeds of the melt through the extrusion die and by the sizes of the individual die lips. According to some embodiments, the total thickness of the multiple layer interlayer can be at least about 13 mils, at least about 20, at least about 25, at least about 27, at least about 30, at least about 31 mils and/or not more than about 95, not more than about 75, not more than about 70, not more than about 65, not more than about 60 mils, or it can be in the range of from about 13 to about 75 mils, about 25 to about 70 mils, or about 30 to 60 mils. When the interlayer comprises two or more polymer layers, each of the layers can have a thickness of at least about 2, at least about 3, at least about 4, at least about 5, at least about 6, at least about 7, at least about 8, at least about 9, at least about 10 mils and/or not more than about 50, not more than about 40, not more than about 30, not more than about 20, not more than about 17, not more than about 15, not more than about 13, not more than about 12, not more than about 10, or not more than about 9 mils. In some embodiments, each of the layers may have approximately the same thickness, while in other embodiments, one or more layers may have a different thickness than one or more other layers within the interlayer. Other thicknesses may be selected depending on the desired application and properties.

In some embodiments wherein the interlayer comprises at least three polymer layers, one or more of the inner layers can be relatively thin, as compared to the other outer layers. For example, in some embodiments wherein the multiple layer interlayer is a three-layer interlayer, the innermost layer can have a thickness of not more than about 15, not more than about 12, not more than about 10, not more than about 9, not more than about 8, not more than about 7, not more than about 6, not more than about 5 mils, or it may have a thickness in the range of from about 2 to about 12 mils, about 3 to about 10 mils, or about 4 to about 9 mils. In the same or other embodiments, the thickness of each of the outer layers can be at least about 4, at least about 5, at least about 6, at least about 7 mils and/or not more than about 15, not more than about 13, not more than about 12, not more than about 10, not more than about 9, not more than about 8 mils, or can be in the range of from about 2 to about 15, about 3 to about 13, or about 4 to about 10 mils. When the interlayer includes two outer layers, these layers can have a combined thickness of at least about 9, at least about 13, at least about 15, at least about 16, at least about 18, at least about 20, at least about 23, at least about 25, at least about 26, at least about 28, or at least about 30 mils, and/or not more than about 73, not more than about 60, not more than about 50, not more than about 45, not more than about 40, not more than about 35 mils, or in the range of from about 9 to about 70 mils, about 13 to about 40 mils, or about 25 to about 35 mils.

According to some embodiments, the ratio of the thickness of one of the outer layers to one of the inner layers in a multiple layer interlayer can be at least about 1.4:1, at least about 1.5:1, at least about 1.8:1, at least about 2:1, at least about 2.5:1, at least about 2.75:1, at least about 3:1, at least about 3.25:1, at least about 3.5:1, at least about 3.75:1, or at least about 4:1. When the interlayer is a three-layer interlayer having an inner core layer disposed between a pair of outer skin layers, the ratio of the thickness of one of the skin layers to the thickness of the core layer may fall within one or more of the ranges above. In some embodiments, the ratio of the combined thickness of the outer layers to the inner layer can be at least about 2.25:1, at least about 2.4:1, at least about 2.5:1, at least about 2.8:1, at least about 3:1, at least about 3.5:1, at least about 4:1, at least about 4.5:1, at least about 5:1, at least about 5.5:1, at least about 6:1, at least about 6.5:1, or at least about 7:1 and/or not more than about 30:1, not more than about 20:1, not more than about 15:1, not more than about 10:1, not more than about 9:1, not more than about 8:1.

Multiple layer interlayers as described herein can comprise generally flat interlayers having substantially the same thickness along the length, or longest dimension, and/or width, or second longest dimension, of the sheet. In some embodiments, however, the multiple layer interlayers of the present invention can be tapered, or wedge-shaped, interlayers that comprise at least one tapered zone having a wedge-shaped profile. Tapered interlayers have a changing thickness profile along at least a portion of the length and/or width of the sheet, such that, for example, at least one edge of the interlayer has a thickness greater than the other. When the interlayer is a tapered interlayer, at least 1, at least 2, at least 3, or more of the individual resin or polymer layers may include at least one tapered zone. Tapered interlayers may be particularly useful in, for example, heads-up display (HUD) panels in automotive and aircraft applications.

In view of the above, embodiments of the present invention include a polymer interlayer, and/or a laminated glass panel that includes a polymer interlayer, that resists formation of optical defects. The polymer interlayer may comprise a core layer, a first skin layer, and a second skin layer. The core layer will generally be positioned between the first and second skin layers, such that the skin layers sandwich the core layer. Notably, however, a portion of the interlayer may have no core layer present. It has been a known problem that unwanted bubbles can form in the core layer of an interlayer, particularly at or near the edge or trim of the interlayer at or near the edge of a laminated glass panel that includes the interlayer. Embodiments of the present invention solve such bubble formation problem by excluding the presence of the core layer over a least a portion of the interlayer and/or of the glass panel that includes the interlayer.

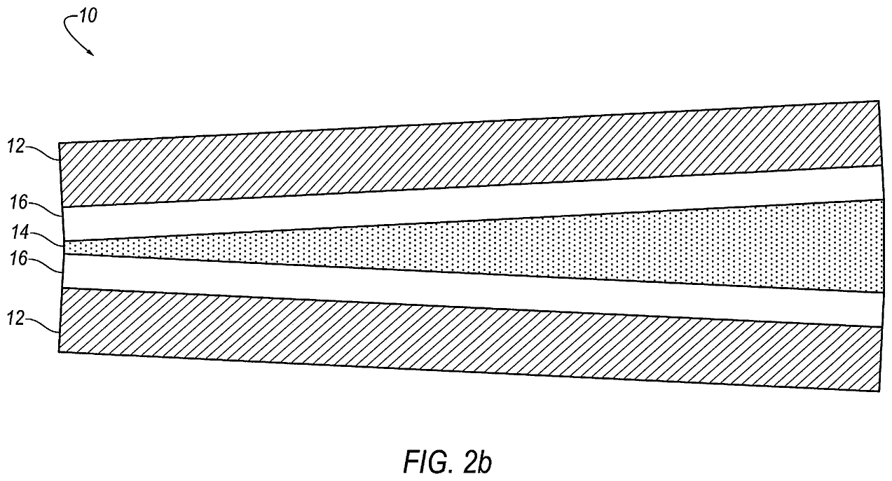

In more detail, FIG. 3 is a top view of a laminated glass panel that comprises a polymer interlayer, formed according to embodiments of the present invention. The polymer interlayer is sandwiched between a pair of glass sheets. Reference letter “A” illustrates the entire area of the laminated glass panel and/or the interlayer. Reference number 20 illustrates a portion of the laminated glass panel and/or the interlayer in which the core layer is not present (referred to herein as the “non-core portion”). In some embodiments, the non-core portion 20 may be at or adjacent an edge of the laminated glass panel and/or the interlayer. For example, the laminated glass panel and/or the interlayer may be shaped as a rectangle. The non-core portion 20 may extend along one of the four sides or edges of the laminated glass panel and/or the interlayer (e.g., along the top, bottom, left, or right side/edge). In other embodiments, the non-core portion 20 may extend around two, three, or all four sides or edges of the laminated glass panel and/or the interlayer. In some specific embodiments, the non-core portion 20 will extend along a top edge of the laminated glass panel and/or the interlayer. In some such embodiments, the interlayer may have a wedge-shaped, non-uniform thickness, with the thickness increasing from bottom to top of the laminated glass panel and/or the interlayer. As such, with the non-core portion 20 extending along the top edge of the laminated glass panel and/or the interlayer, the non-core portion 20 is present along a relatively “thicker” portion of the laminated glass panel and/or the interlayer.

In some embodiments, the non-core portion 20 may extend a distance of about 40 cm from the edge of the laminated glass panel and/or the interlayer. In certain embodiments, the non-core portion 20 may extend a distance of about at least 0.2 cm, at least 0.5 cm, at least 1.0 cm, at least 2 cm, at least 3 cm, at least 10 cm, at least 15 cm, at least 20 cm, at least 30 cm, or at least 40 cm from the edge of the laminated glass panel and/or the interlayer. In other embodiments, the non-core portion 20 may extend a distance of about no more than 40 cm, no more than 30 cm, no more than 20 cm, no more than 15 cm, no more than 10 cm, no more than 3 cm, no more than 2 cm, no more than 1.0 cm, no more than 0.5 cm, or no more than 0.2 cm from the edge of the laminated glass panel and/or the interlayer. In some specific embodiments, the non-core portion 20 may extend a distance between about 0.2 and 0.5 cm, between about 0.2 and 1.0 cm, between about 0.2 and 2 cm, between about 0.2 and 3 cm, between about 0.2 and 10 cm, between 0.2 and 15 cm, between about 0.2 and 20 cm, between about 0.2 and 30 cm, between about 0.2 and 40 cm, between about 0.5 and 1.0 cm, between about 0.5 and 2 cm, between about 0.5 and 3 cm, between about 0.5 and 10 cm, between 0.5 and 15 cm, between about 0.5 and 20 cm, between about 0.5 and 30 cm, between about 0.5 and 40 cm, between about 1.0 and 2 cm, between about 1.0 and 3 cm, between about 1.0 and 10 cm, between 1.0 and 15 cm, between about 1.0 and 20 cm, between about 1.0 and 30 cm, between about 1.0 and 40 cm, between about 2 and 3 cm, between about 2 and 10 cm, between 2 and 15 cm, between about 2 and 20 cm, between about 2 and 30 cm, between about 2 and 40 cm, between about 3 and 10 cm, between 3 and 15 cm, between about 3 and 20 cm, between about 3 and 30 cm, between about 3 and 40 cm, between about 10 and 15 cm, between about 10 and 20 cm, between about 10 and 30 cm, between about 10 and 40 cm, between about 15 and 20 cm, between about 15 and 30 cm, between about 15 and 40 cm, between about 20 and 30 cm, between about 20 and 40 cm, and/or between about 30 and 40 cm from the edge of the laminated glass panel and/or the interlayer.

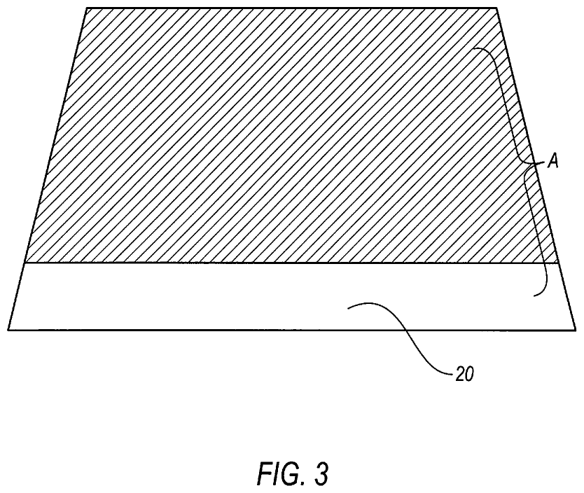

Examples of laminated glass panels with polymer interlayers having non-core portions 20, according to embodiments of the present invention are illustrated in FIGS. 4-6. FIG. 4 shows a laminated glass panel 30 having a pair of glass sheets 12 sandwiching a trilayer interlayer. The interlayer comprises a pair of skin layers 16 sandwiching a core layer 14. Notably, however, a portion of the interlayer is formed without a core layer 14. Specifically, a non-core portion 20 extends from the right edge of the laminated glass panel 30 and/or the interlayer. Such a non-core portion 20 may comprise the same resin material as the skin layers 16. Specifically, as will be described in more detail below, during manufacture of the laminated glass panel 30 and/or the interlayer, the core layer 14 may be prevented from being formed within the non-core portion 20 of the laminated glass panel 30 and/or the interlayer. As a result, the resin forming the skin layers 16 may fill in such non-core portion, such that the volume 32 of the interlayer that forms the non-core portion 20 comprises the same material as the skin layers 16. As result, the non-core portion 20 of the interlayer may comprise a monolithic layer containing essentially only the material (e.g., resin/melt) of the skin layers 16.

The laminated glass panel 30 of FIG. 4 includes a polymer interlayer with a generally constant thickness. The non-core portion 20 of the laminated glass panel 30 and/or the interlayer is shown extending from the right edge of the laminated glass panel 30 and/or the interlayer. Such right edge may be the top edge of the laminated glass panel 30 and/or the interlayer. For example, if the laminated glass panel 30 is an automotive windshield, the windshield may normally be oriented vertically (e.g., forming the front windshield of a vehicle), such that the right edge may form the top edge of the windshield. As a result, the non-core portion 20 may extend down a distance from the top edge of the laminated glass panel 30 and/or the interlayer.

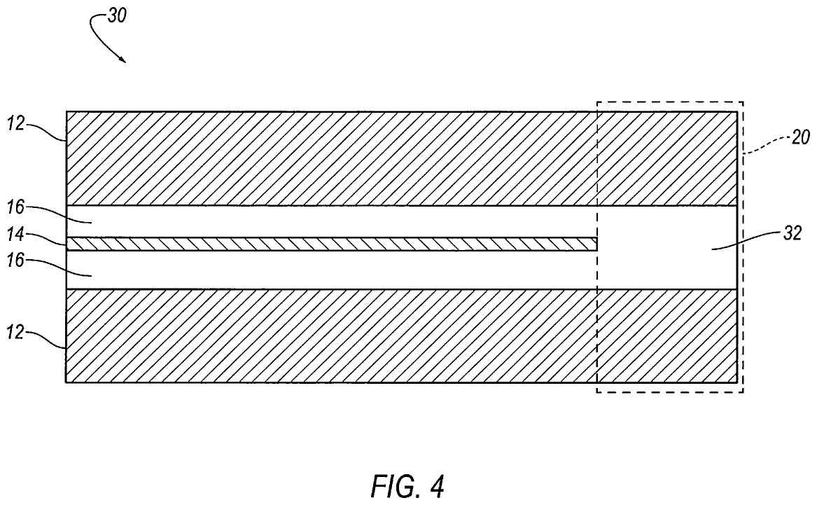

FIG. 5 shows another laminated glass panel 40 having a pair of glass sheets 12 sandwiching a trilayer interlayer. The interlayer comprises a pair of skin layers 16 sandwiching a core layer 14. Notably, however, a portion of the interlayer is formed without a core layer 14. Specifically, a non-core portion 20 extends from the right edge of the laminated glass panel 40 and/or the interlayer. Such a non-core portion 20 may comprise the same resin material as the skin layers 16. Specifically, as will be described in more detail below, during manufacture of the laminated glass panel 40 and/or the interlayer, the core layer 14 may be prevented from being formed within the non-core portion 20 of the laminated glass panel 40 and/or the interlayer. As a result, the resin forming the skin layers 16 may fill in such non-core portion, such that the volume 42 of the interlayer that forms the non-core portion 20 comprises the same material as the skin layers 16.

The laminated glass panel 40 of FIG. 5 includes a polymer interlayer with a non-constant thickness. Specifically, the thickness of the interlayer increases along at least a portion of its length, so as to form a wedge-shape. As such, the laminated glass panel 40 may be in the form of an automotive windshield, with the interlayer aiding with heads-up display (HUD) functionality (e.g., to reduce ghost images). Although FIG. 5 illustrates both of the skin layers 16 having a non-constant thickness, embodiments contemplate that only one of the layers of the interlayer (e.g., one of the skin layers 16 or the core layer 14) will have a non-constant thickness. The non-core portion 20 of the laminated glass panel 40 and/or the interlayer is shown extending from the right edge of the laminated glass panel 40 and/or the interlayer. Such right edge may be the top edge of the laminated glass panel 40 and/or the interlayer. For example, if the laminated glass panel 40 is an automotive windshield, the right edge may form the top edge of the windshield, such that the non-core portion 20 extends down a distance from the top edge of the laminated glass panel 40 and/or the interlayer. Further, the upper side of the interlayer is thicker than the lower side.

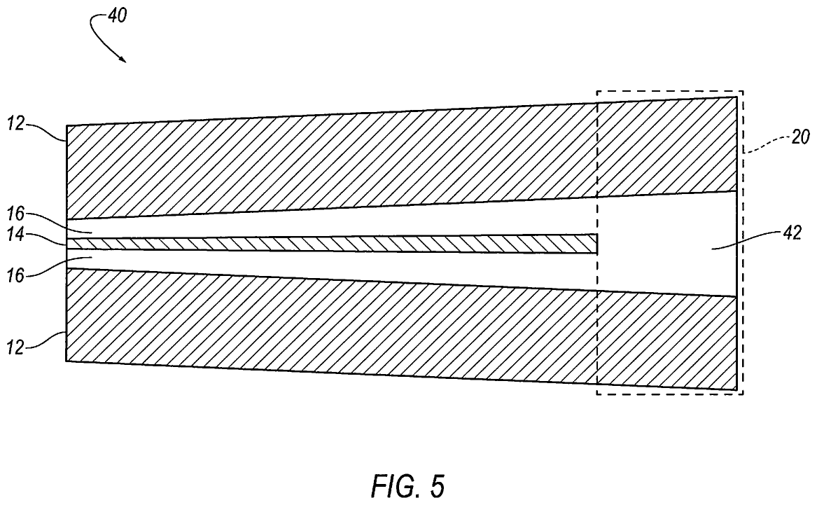

FIG. 6 shows another laminated glass panel 50 having a pair of glass sheets 12 sandwiching a trilayer interlayer. The interlayer comprises a pair of skin layers 16 sandwiching a core layer 14. Notably, however, a portion of the interlayer is formed without a core layer 14. Specifically, a non-core portion 20 extends from the left edge of the laminated glass panel 40 and/or the interlayer. Such a non-core portion 20 may comprise the same resin material as the skin layers 16. Specifically, as will be described in more detail below, during manufacture of the laminated glass panel 50 and/or the interlayer, the core layer 14 may be prevented from being formed within the non-core portion 20 of the laminated glass panel 50 and/or the interlayer. As a result, the resin forming the skin layers 16 may fill in such non-core portion, such that the volume 52 of the interlayer that forms the non-core portion 20 comprises the same material as the skin layers 16.

The laminated glass panel 50 of FIG. 6 includes a polymer interlayer with a non-constant thickness. Specifically, the thickness of the interlayer increases along at least a portion of its length, so as to form a wedge-shape. As such, the laminated glass panel 50 may be in the form of an automotive windshield, with the interlayer aiding with heads-up display (HUD) functionality (e.g., to reduce ghost images). Although FIG. 6 illustrates both of the skin layers 16 having a non-constant thickness, embodiments contemplate that only one of the layers of the interlayer (e.g., one of the skin layers 16 or the core layer 14) may have a non-constant thickness. The non-core portion 20 of the laminated glass panel 40 and/or the interlayer is shown extending from the left edge of the laminated glass panel 50 and/or the interlayer. Such left edge may be the bottom edge of the laminated glass panel 50 and/or the interlayer. For example, if the laminated glass panel 50 is an automotive windshield, the left edge may form the bottom edge of the windshield, such that the non-core portion 20 extends up a distance from the bottom edge of the laminated glass panel 50 and/or the interlayer. Further, the upper side of the interlayer is thicker than the lower side.

Beneficially, the laminated panels and/or the interlayers described above, i.e., with the non-core portions, provide for reduced optical defects (e.g., bubbles) without a reduction in other optical, mechanical, and acoustic characteristics. Specifically, as was discussed above, polymer interlayers and/or laminated glass panels that include polymer interlayers are known to generate optical defects in the form of bubbles. Such bubbles are commonly generated in the core layer of the interlayers, and are often generated at the edges and/or trim of the interlayers near the edge of a laminated glass panel that includes the interlayer. By removing the core layer from a portion of the interlayer, and particularly at the edges of the interlayer, the interlayer and/or the resulting laminated panel can be formed with reduced and/or no bubbles in the edges and/or trim. Furthermore, however, the resulting laminated panels are found to have little or no reduction in in other optical, mechanical, and acoustic characteristics.

Specifically, laminated glass panels and/or polymer interlayers formed according to embodiments of the present invention, which include non-core layer portions, may be formed with no more than 5, no more than 4, no more than 3, no more than 2, no more than 1, or with no (0) bubbles within the edges or within the trim of the laminated glass panels and/or polymer interlayers when measured according to the edge or trim bubble test discussed below. Furthermore, the laminated glass panels and/or polymer interlayers formed according to embodiments of the present invention may have average sound transmission loss properties of at least 39.0, at least 39.1 dB, at least 39.2 dB, at least 39.3 dB, at least 39.4 dB, at least 39.5 dB, at least 39.6 dB, at least 39.7 dB, or at least 39.8 dB in the 2 to 4 KHz frequency range, when at least 5%, at least 10, at least 15%, at least 17%, at least 20%, at least 23%, at least 25%, at least 27%, or at least 29% of the area of the laminated glass panels and/or polymer interlayers are formed without a core layer (i.e., with a non-core portion), when tested according to ASTM E90 discussed below.

Embodiments of the present invention provide for various processes for forming interlayers, or laminated panels with interlayers, having non-core portions. For example, during co-extrusion of an interlayer, a blocking element (e.g., a rectangular, triangular, or circular rod, tube, or block) may be positioned within the manifold or opening of the die. Such a blocking element may be particularly configured to block the flow of the core layer melt/resin through the manifold and/or the opening, such that the core layer is not formed in the non-core portion of the interlayer and/or the resulting glass panel. As a result of blocking the core layer melt/resin, the skin layer melt/resin may flow into the interlayer volume defined by the non-core portion. Alternatively, the non-core portion may be created within the interlayer upon the lamination of the interlayer and/or of the resulting glass panel. For example, a portion of the core layer may be cut away (e.g., via a knife or other cutting mechanism) from the remaining portions of the interlayer to create the non-core portion after the interlayer and/or the resulting glass panel has been formed.

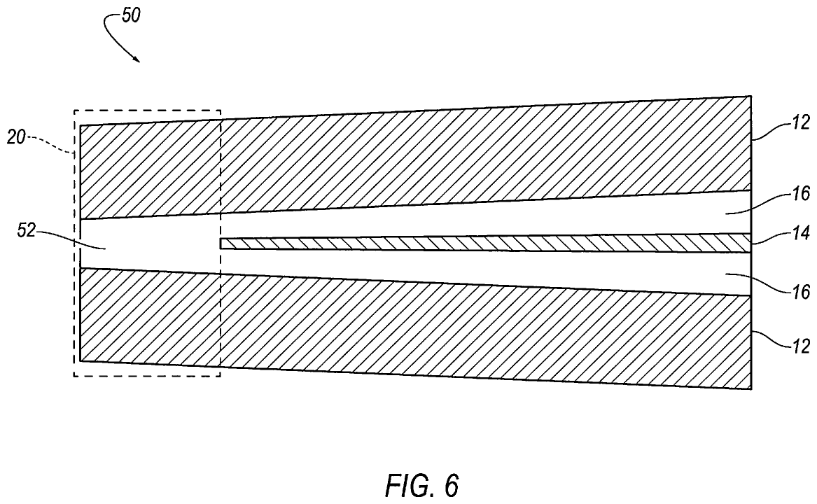

Although the non-core portion may, as described above, comprise a monolithic layer containing essentially only the material (e.g., resin/melt) of the skin layers, it is contemplated that the core layer may, nonetheless, extend partly into the non-core portion. For example, FIG. 7 illustrates a laminated glass panel that includes a polymer interlayer in which the core layer extends partly into the non-core portion 20 of the polymer interlayer. Specifically, the core layer may extend with a diminishing thickness at least partly into the non-core portion 20 until the thickness of the core layer reaches zero. Such an extension of the core layer is referred to a core layer gradient 60. This core layer gradient 60 may be formed naturally during the extrusion process due to the flow of the resins of the core and/or skin layers. Alternatively, the blocking element may have a specific shape that facilitates the creation of a core layer gradient 60. For instance, the blocking element may have a notch or V-shape so as to create the core layer gradient 60 that extends at least partly into the non-core portion of the polymer interlayer.

In view of the above, embodiments provide for the creation of a polymer interlayer that resists formation of optical defects. The polymer interlayer may comprise a first polymer layer (e.g., a core layer), a second polymer layer (e.g., a first skin layer), and a third polymer layer (e.g., a second skin layer). The first polymer layer will generally be positioned between the second polymer layer and the third polymer layer. The first polymer layer has a glass transition temperature of less than about 20° C., and the second and third polymer layers each have a glass transition temperature of more than about 25° C. As such, the first polymer layer (e.g., the core layer) is generally softer than the second and third polymer layers (e.g., the skin layers). The polymer interlayer has an edge, and the first polymer layer is not present within the polymer interlayer from the edge of the polymer interlayer to a distance between 0.2 and 40 cm from the edge.

Such a polymer interlayer may be formed according to the following method. The method comprises the step of extruding a first polymer melt to form a first polymer layer. The first polymer layer has a glass transition temperature of less than about 20° C. An additional step includes extruding a second polymer melt to form a second polymer layer and a third polymer layer. The second and third polymer layers each have a glass transition temperature of more than about 25° C. The first polymer layer is positioned between the second polymer layer and the third polymer layer. The polymer interlayer has an edge. The first polymer layer is not present within the polymer interlayer from the edge of the polymer interlayer to a distance between 0.2 and 40 cm from the edge. Furthermore, a laminated glass panel, such as a vehicle windshield, can be created by laminating the polymer interlayer between a pair of glass sheets, as described herein. The resulting laminated glass panel can include an edge with no core layer in its associated polymer interlayer.

### Example 1

Two sets of ten laminated glass panels were formed. Each of the glass panels included a wedge-shaped, acoustic polymer interlayer sandwiched between a pair of glass sheets. The polymer interlayer comprised a soft core layer sandwiched between a pair of stiff skin layers. A first set of ten laminated glass panels, EX1-IIL1, was formed with polymer interlayers having non-core portions. Specifically, each of the EX1-IIL1 glass panels included 14 cm of core layer of the associated interlayer removed from a top edge of the glass panel. It is noted that the top edge of the glass panel was the thicker edge of the glass panel (due to the wedge shape of the interlayer). A second set of ten laminated glass panels, EX1-IIL2, was formed with no portion of the core layers removed from the polymer interlayers.

Each laminated glass panel was formed with a pair of 2.3 mm glass sheets. Each glass panel included a 1.5 to 2 mm section of interlayer trim extending from the top edge of the glass sheets. The resulting laminated glass panels were generally square, measuring 30 cm by 30 cm. The laminated glass panels were produced by nip roll deairing and autoclave to finish lamination. The autoclave was set at about 75% relative humidity, a holding temperature of 149° C., a holding time of thirty-four minutes, and holding pressure of 13.8 bar.

After the autoclaving, the laminated glass panels were visually examined to determine the number of bubbles in the panels. It should be understood that edge bubbles are bubbles formed within the laminated glass panels, adjacent the edges of the glass panels. Specifically, edge bubbles are bubbles that form within the polymer interlayers of the laminated glass panels, within about 5 mm from the edges of the glass sheets. On the other hand, trim bubbles are bubbles found in the trim sections of the polymer interlayers that extend from the edges of the glass sheets. Bubbles found in the edges or in the trim are usually circular, having a diameter from a few tenths of a millimeter to about 1 millimeter. The visual detection of bubbles within the edges of the laminated glass panels is referred to herein as the “edge bubble test” (with the laminated glass panels manufactured in the manner discussed above), whereas the visual detection of bubbles within the sections of trim extending from the glass sheets is referred to herein as the “trim bubble test” (with the laminated glass panels manufactured in the manner discussed above). The results of the above-described bubble tests are reproduced below in Table 1, which shows the total number of trim and edge bubbles counted for both sets of laminated glass panels, EX1-IIL1 and EX1-IIL2.

TABLE 1

| | Total number of edge bubbles | Total number of trim bubbles |
|---|---|---|
| | found in the ten laminated | found in the ten laminated |
| | glass panels | glass panels |
| EX1-IIL1 | 0 | 0 |
| EX1-IIL2 | 5 | 3 |

As illustrated by the data from Table 1, the laminated glass panels having interlayers with non-core portions had significantly fewer bubbles formed in the trim and/or edges of the laminated glass panels. Specifically, the laminated glass panels having interlayers with 14 cm of core layer absent from the top edges of the laminate glass panels were found to have no bubbles in the non-core portions of the trim and/or edges of the glass panels. In contrast, laminated glass panels with interlayers having core layers present throughout the entireties of the interlayers were found to have varying levels of bubbles within the trim and/or edges of the glass panels.

### Example 2

Eight laminated glass panels, EX2-IIL1 to EX2-IIL8, were formed, each having varying percentages of interlayer areas with non-core portions. Each of the glass panels included a wedge-shaped, acoustic polymer interlayer (i.e., a trilayer with a core layer sandwiched between a pair of skin layers) sandwiched between a pair of 2.3 mm glass sheets. The polymer interlayers were co-extruded. The resulting glass panels were each generally rectangular, with a dimension of 50 cm by 80 cm. The 80 cm edge of each glass panel was the “longer edge,” while the 50 cm edge was the “shorter edge.”

EX2-IIL1 was formed with an interlayer having no non-core portion (i.e., the non-core portion formed 0.00% of the area of the glass panel and/or the interlayer), such that the core layer extended to each of the edges of the glass panel and/or the interlayer. The longer edges for EX2-IIL1 were in the machine direction of the interlayer as extruded.

EX2-IIL2 was formed with an interlayer having a non-core portion extending about 2.5 cm from one of the longer edges of the glass panel and/or the interlayer (i.e., the non-core portion formed 4.80% of the area of the glass panel and/or the interlayer). The longer edges for EX2-IIL2 were in the machine direction of the interlayer as extruded.

EX2-IIL3 was formed with an interlayer having a non-core portion extending about 5 cm from one of the longer edges of the glass panel and/or the interlayer (i.e., the non-core portion formed 9.98% of the area of the glass panel and/or the interlayer). The longer edges for EX2-IIL3 were in the machine direction of the interlayer as extruded.

EX2-IIL4 was formed with an interlayer having a non-core portion extending about 14 cm from one of the longer edges of the glass panel and/or the interlayer (i.e., the non-core portion formed 28.94% of the area of the glass panel and/or the interlayer). The longer edges for EX2-IIL4 were in the machine direction of the interlayer as extruded.

EX2-IIL5 was formed with an interlayer having no non-core portion (i.e., the non-core portion formed 0.00% of the area of the glass panel and/or the interlayer), such that the core layer extended to each of the edges of the glass panel and/or the interlayer. The shorter edges for EX2-IIL5 were in the cross-machine direction of the interlayer as extruded.

EX2-IIL6 was formed with an interlayer having a non-core portion extending about 2.5 cm from one of the shorter edges of the glass panel and/or the interlayer (i.e., the non-core portion formed 4.46% of the area of the glass panel and/or the interlayer). The shorter edges for EX2-IIL6 were in the cross-machine direction of the interlayer as extruded.

EX2-IIL7 was formed with an interlayer having a non-core portion extending about 5 cm from one of the shorter edges of the glass panel and/or the interlayer (i.e., the non-core portion formed 6.75% of the area of the glass panel and/or the interlayer). The shorter edges for EX2-IIL7 were in the cross-machine direction of the interlayer as extruded.

EX2-IIL8 was formed with an interlayer having a non-core portion extending about 14 cm from one of the shorter edges of the glass panel and/or the interlayer (i.e., the non-core portion formed 17.50% of the area of the glass panel and/or the interlayer). The shorter edges for EX2-IIL8 were in the cross-machine direction of the interlayer as extruded.

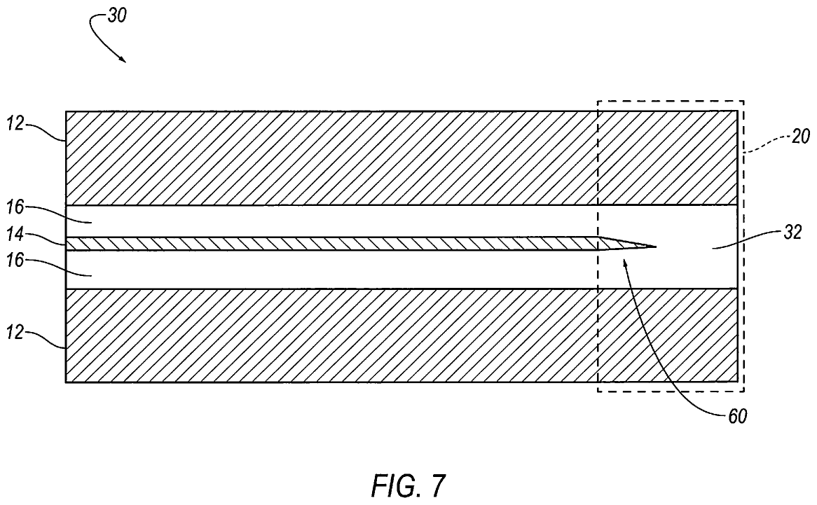

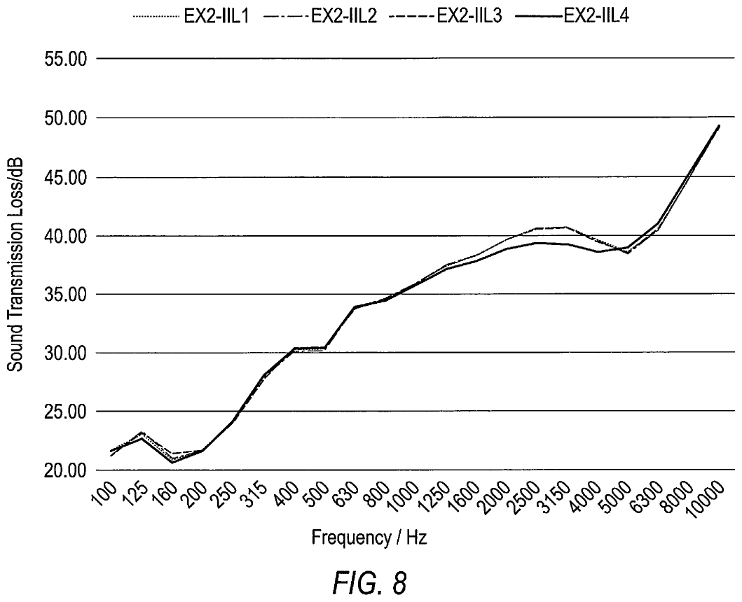

Upon formation of the laminated glass panels EX2-IIL1 to EX2-IIL8, each glass panel was tested for sound transmission loss (“STL”) in accordance with ASTM E90 at 20° C. STL curves were plotted based on the resulting data and illustrated in FIGS. 8 and 9. In addition, data in the form of average STL values, in the 2-4 KHz range/dB and 5-10 KHz range/dB, for each laminated glass panel is provided below in Table 2.

TABLE 2

| | Non-Core Layer | Average STL in 2- | Average STL in 5- |
|---|---|---|---|
| | Percentage Area | 4 KHz Range/dB | 10 KHz range/dB |
| EX2-IIL1 | 0.00 | 40.14 | 43.22 |
| EX2-IIL2 | 4.80 | 40.13 | 43.21 |
| EX2-IIL3 | 9.98 | 40.07 | 43.25 |
| EX2-IIL4 | 28.94 | 39.02 | 43.62 |
| EX2-IIL5 | 0.00 | 39.98 | 43.30 |
| EX2-IIL6 | 4.46 | 39.93 | 43.34 |
| EX2-IIL7 | 6.75 | 39.84 | 43.35 |
| EX2-IIL8 | 17.50 | 39.20 | 43.45 |

As was described previously, use of trilayer interlayers with a soft core polymer layer sandwiched between a pair of stiff skin polymer layers can be used in a laminated glass panel to create an automotive windshield that provides beneficial acoustic properties. Specifically, the soft core layer is understood to provide a noise dampening effect so as to provide a quieter vehicle cabin. As such, it was surprising to find, as illustrated in Table 2 and FIGS. 8 and 9, that STL performance in the glass panels was not significantly inhibited or negatively impacted by removing portions of the core layers of the interlayers.

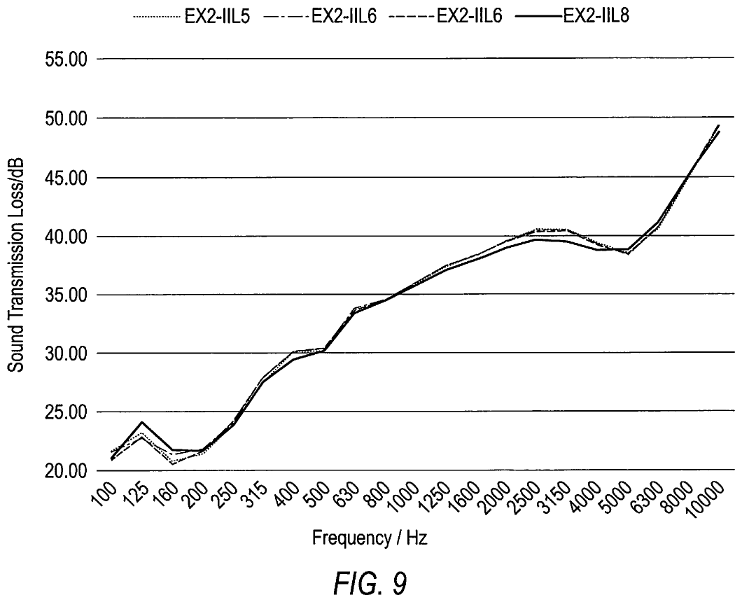

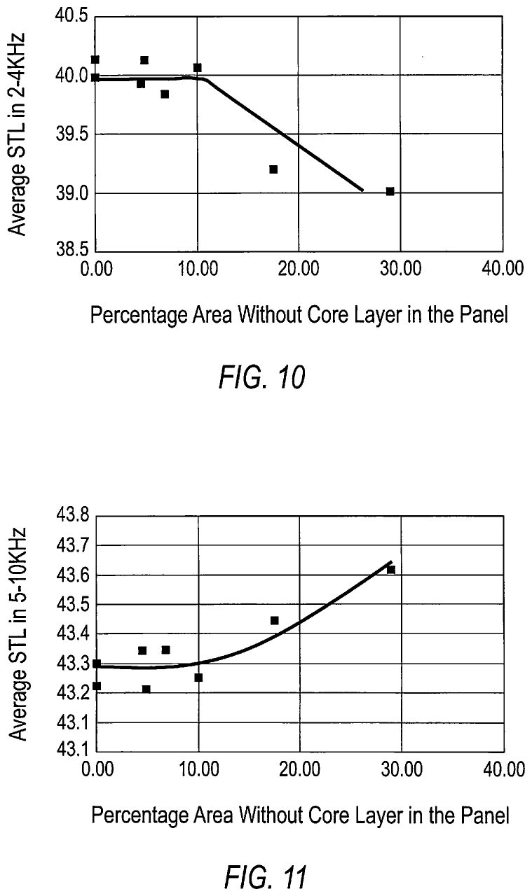

Furthermore, charts from FIGS. 10 and 11 illustrate the average STL in each of the 2 to 4 KHz and the 5 to 10 KHz frequency ranges for each of EX2-IIL1 to EX2-IIL8. For the laminated glass panels with more than 10% of the area of the glass panel and/or the interlayer having the core layer removed, the average STL decreased slightly in the 2 to 4 KHz frequency range, however, the STL in the 5 to 10 KHz frequency range increased slightly. As a result, the net effect on overall STL for the glass panels that included larger areas (e.g., 17.50 to 28.94%) of core layer being removed is insignificant.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, or characteristics given for any single component of the present disclosure can be used interchangeably with any ranges, values or characteristics given for any of the other components of the disclosure, where compatible, to form an embodiment having defined values for each of the components, as given herein throughout. For example, a polymer layer can be formed comprising plasticizer content in any of the ranges given in addition to any of the ranges given for residual hydroxyl content, where appropriate, to form many permutations that are within the scope of the present invention but that would be cumbersome to list.

What is claimed is:

1. A polymer interlayer that resists formation of optical defects, the polymer interlayer comprising:
a first polymer layer;
a second polymer layer; and
a third polymer layer,
wherein said first polymer layer is positioned between said second polymer layer and said third polymer layer,
wherein said first polymer layer has a glass transition temperature of less than about 20° C., and wherein said second and third polymer layers have a glass transition temperature of more than about 25° C.,
wherein said polymer interlayer has an edge, and wherein said first polymer layer is not present within a portion of said polymer interlayer, wherein the portion of said polymer interlayer extends a distance X from the edge of said polymer interlayer, wherein the distance X is between 0.2 and 40 cm.

2. The polymer interlayer of claim 1, wherein the distance X is between 0.2 and 30 cm, between 0.2 and 20 cm, between 0.2 and 15 cm, between 0.2 and 10 cm, and/or between 0.2 and 5.0 cm.

3. The polymer interlayer of claim 1, wherein a resin of the first, second, and/or third polymer layers comprises PVB.

4. The polymer interlayer of claim 1, wherein a thickness of said polymer interlayer is generally constant along a length of said polymer interlayer.

5. The polymer interlayer of claim 1, wherein a thickness of said polymer interlayer varies along a length of said polymer interlayer, such that said polymer interlayer has a wedge shape.

6. The polymer interlayer of claim 1, wherein said polymer interlayer is configured to be laminated between a pair of glass sheets to form a windshield, and wherein upon lamination of the windshield, the edge of said polymer interlayer is positioned adjacent a top of the windshield.

7. The polymer interlayer of claim 6, wherein upon lamination of the windshield, said first polymer layer is not present within a portion of the windshield, wherein the portion of the windshield extends a distance Y from a top edge of the glass sheets, wherein the distance Y is between 0.2 and 40 cm, between 0.2 and 30 cm, between 0.2 and 20 cm, between 0.2 and 15 cm, between 0.2 and 10 cm, and/or between 0.2 and 5.0 cm.

8. The polymer interlayer of claim 1, wherein the edge of said polymer interlayer is a first edge, and wherein said polymer interlayer includes a second edge, a third edge, and a fourth edge, wherein said first polymer layer is not present within said polymer interlayer for the distance X from two or more of the first edge, the second edge, the third edge, and/or the fourth edge of said polymer interlayer.

9. The polymer interlayer of claim 1, wherein when said polymer interlayer is laminated between a pair of glass sheets to form a laminated glass panel, such glass panel includes no more than two edge bubbles, no more than one edge bubble, and/or no edge bubbles, as determined using the edge bubble test.

10. The polymer interlayer of claim 1, wherein when said polymer interlayer is laminated between a pair of 2.3 mm thickness glass sheets to form a laminated glass panel, such glass panel has an average sound transmission loss of at least 39.0 dB in a 2 to 4 KHz frequency range.

11. The polymer interlayer of claim 1, wherein said polymer interlayer is formed by co-extrusion.

12. A method of forming a polymer interlayer that resists formation of optical defects, said method comprising the steps of:
(a) extruding a first polymer melt to form a first polymer layer, wherein the first polymer layer has a glass transition temperature of less than about 20° C.; and
(b) extruding a second polymer melt to form a second polymer layer and a third polymer layer, wherein the second and third polymer layers have a glass transition temperature of more than about 25° C.,
wherein the first polymer layer is positioned between the second polymer layer and the third polymer layer,
wherein the polymer interlayer has an edge, and wherein the first polymer layer is not present within a portion of the polymer interlayer, wherein the portion of the polymer interlayer extends a distance X from the edge of the polymer interlayer, wherein the distance X is between 0.2 and 40 cm.

13. The method of claim 12, wherein the distance X is between 0.2 and 30 cm, between 0.2 and 20 cm, between 0.2 and 15 cm, between 0.2 and 10 cm, and/or between 0.2 and 5.0 cm.

14. The method of claim 12, wherein a thickness of said polymer interlayer is generally constant along a length of said polymer interlayer.

15. The method of claim 12, wherein a thickness of said polymer interlayer varies along a length of said polymer interlayer, such that said polymer interlayer has a wedge shape.

16. The method of claim 12, further including the step of laminating the polymer interlayer between a pair of glass sheets to form a windshield, and wherein upon lamination of the windshield, the edge of the polymer interlayer is positioned adjacent a top of the windshield.

17. The method of claim 16, wherein upon lamination of the windshield, the first polymer layer is not present within a portion of the windshield, wherein the portion of the windshield extends a distance Y from a top edge of the glass sheets, wherein the distance Y is between 0.2 and 40 cm, between 0.2 and 30 cm, between 0.2 and 20 cm, between 0.2 and 15 cm, between 0.2 and 10 cm, and/or between 0.2 and 5.0 cm.

18. The method of claim 16, wherein upon lamination of the windshield, the windshield includes no more than two edge bubbles, no more than one edge bubble, and/or no edge bubbles, as determined using the edge bubble test.

19. The method of claim 16, wherein upon lamination of the windshield, the windshield has an average sound transmission loss of at least 39.0 dB in a 2 to 4 KHz frequency range.

20. The method of claim 12, wherein the edge of the polymer interlayer is a first edge, and wherein the polymer interlayer includes a second edge, a third edge, and a fourth edge, wherein the first polymer layer is not present within the polymer interlayer for the distance X from two or more of the first edge, the second edge, the third edge, and/or the fourth edge of the polymer interlayer.
